(19) United States
(12) Patent Application Publication
(10) Pub. No.: US 2010/0223093 A1
(43) Pub. Date: Sep. 2, 2010

(54) System and method for intelligently monitoring subscriber's response to multimedia content

(76) Inventor: Robert B. Hubbard, Marina Del Rey, CA (US)

Correspondence Address: Benman, Brown & Williams, Suite 2740, 2049 Century Park East, Los Angeles, CA, 90067, US

(21) Appl. No.: 12/380,485

(22) Filed: Feb. 27, 2009

(51) Int. Cl. G06Q 10/00; G06Q 30/00; G06N 5/02

(52) U.S. Cl. 705/10; 706/20; 705/14.49

(57) ABSTRACT

A system for monitoring a subscriber's behavior. The novel system includes a first sub-system for obtaining a subscriber's responses to multimedia content previously delivered to the subscriber's device and a second sub-system for modifying a profile on the subscriber based on these responses. In an illustrative embodiment, the profile includes data on the subscriber's personal preferences on a plurality of categories, and the second sub-system includes a neural network artificial intelligence engine adapted to automatically refine the personal preferences based on the responses to previous content. The first sub-system includes an applet stored in and executed by the subscriber's device that records the subscriber's responses and actions in a data file and transmits the data file to the second sub-system. The second sub-system receives the recorded responses and actions from the applet and updates the subscriber's profile accordingly.

### BACKGROUND OF THE INVENTION

1. Field of the Invention

The present invention relates to communications systems. More specifically, the present invention relates to systems and methods for delivering multimedia content to media storage devices.

2. Description of the Related Art

Advertisers generally want to target their advertisements toward the individuals who are most likely to respond favorably to their ads. At the same time, most consumers prefer to receive advertisements that fit with their personal interests, to learn about new products and services or promotions and sales on things they might want to purchase, and some consumers would prefer not to receive any advertisements at all. It would therefore be desirable to be able to deliver advertisements to targeted consumers based on their personal interests. This, however, is difficult if not impossible to accomplish using conventional advertising practices.

Most conventional advertising mediums—such as television or radio commercials, print ads in newspapers or magazines, and banners ads on Internet websites—rely on a “spray and pray” approach where advertisements are presented to a large general audience in hopes that some of the people who receive the ad will have a positive response. This approach can be inefficient and unreliable since there is no way to control who will receive the ad.

Advertisers typically use general demographic assumptions on the type of people who might be viewing a particular television show, magazine, website, etc., to help determine where to place an ad. These assumptions usually are not very accurate, resulting in advertisements being viewed by people who have no interest in them, while people who might have been interested never see them. Furthermore, with these advertising mediums, there is no guarantee that the targeted consumers will actually see or pay attention to the advertisements.

Direct mail, email, and telemarketing offer advertisers the ability to target specific individuals. However, these types of advertisements are usually unsolicited and unwanted, and are often discarded or ignored by the recipient. Advertisers generally target an individual based on a previous purchase, catalog request, group membership, or other action from which the advertiser obtained the individual's address, email, or phone number. This approach is therefore also based on loose assumptions that typically are not very accurate. Currently, there is no way of accurately targeting specific individuals with advertisements that match their interests.

Hence, a need exists in the art for an improved system or method for targeting specific individuals with advertisements based on their personal preferences that is more accurate and more efficient than conventional advertising practices.

### SUMMARY OF THE INVENTION

The need in the art is addressed by the system and method for monitoring a subscriber's behavior of the present invention. The novel system includes a first sub-system for obtaining a subscriber's responses to multimedia content previously delivered to the subscriber's device and a second sub-system for modifying a profile on the subscriber based on these responses. In an illustrative embodiment, the profile includes data on the subscriber's personal preferences on a plurality of categories, and the second sub-system includes a neural network artificial intelligence engine adapted to automatically refine the subscriber's personal preferences based on the responses to previous content. The first sub-system includes an applet stored in and executed by the subscriber's device that records the subscriber's responses and actions on the device in a data file and transmits the data file to the second sub-system. The second sub-system receives the recorded responses and actions from the applet and updates the subscriber's profile accordingly. In an illustrative application, the profile is then used to help select content to be sent to the subscriber that matches the subscriber's preferences.

### BRIEF DESCRIPTION OF THE DRAWINGS

FIG. 1 is a simplified block diagram of a system for delivering multimedia content to media storage devices designed in accordance with an illustrative embodiment of the present invention.

FIG. 2 is a simplified flow diagram of a subscriber-side sub-system designed in accordance with an illustrative embodiment of the present invention.

FIG. 3 is a simplified diagram showing illustrative tree branching examples for creating the rules that define the profile refining engine responses in accordance with an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention provides a novel system for intelligently monitoring an individual's behavior patterns and responses to advertisements (or other types of multimedia content). The collected data can then be used to send consumers advertisements that are targeted specifically to their personal preferences. In a preferred embodiment, advertisements are delivered to specific individuals via their cellular phones. The system may also be adapted for use with other types of media storage devices such as personal digital assistants (PDAs), MP3 players, gaming consoles, satellite radio receivers, digital television receivers, GPS navigation devices, or any other personal device with a processor, memory, and communication capability. Advertising via cellular phones offers advertisers the ability to target specific individuals, since cellular phones are typically personal devices used primarily by one person. Cellular phones are also more often with the consumer as compared to other advertising mediums such as televisions, and also offer displays and processing power capable of playing high quality multimedia content.

In a preferred embodiment, in order to avoid unsolicited spamming, consumers must opt-in or subscribe to the advertising service to receive ads via their cellular phones. In exchange, the consumers, or “subscribers”, may receive free or discounted products or services such as airtime, phones, music or game downloads, etc. Upon signing up for the service, subscribers are asked to create a subscriber profile that includes general demographic information (such as age, gender, etc.) as well as their personal preferences on the categories of ads they would prefer to receive (such as, for example, entertainment, sports, food, etc.). The advertising system then uses this information to select which subscribers receive which advertisements.

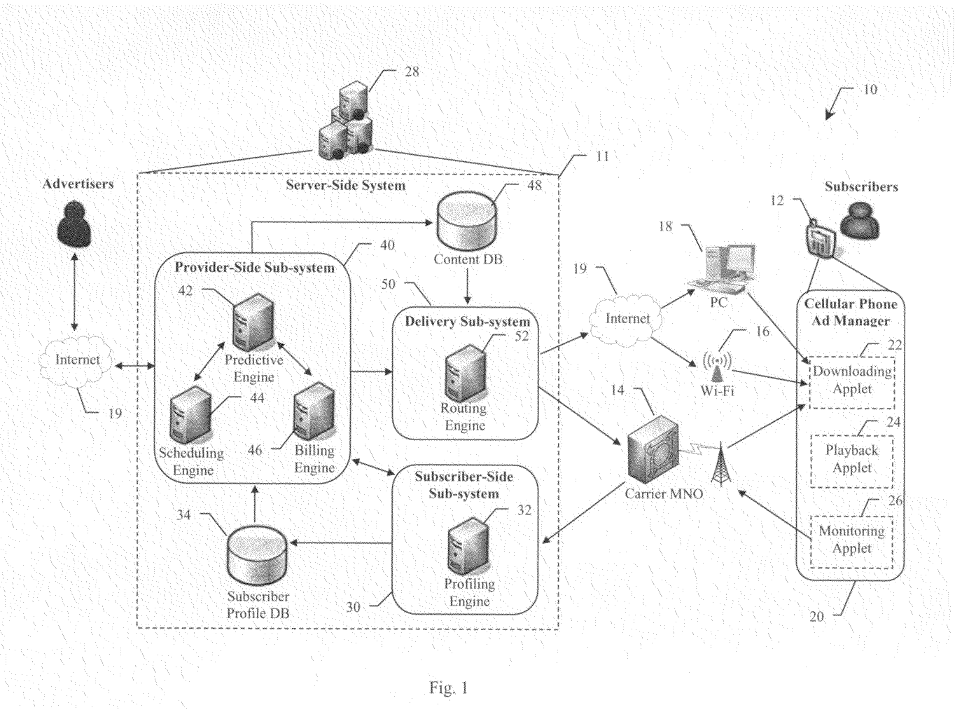

FIG. 1 is a simplified block diagram of a system 10 for delivering multimedia content to personal media storage devices designed in accordance with an illustrative embodiment of the present invention. In the illustrative embodiment, the system 10 includes a server-side system 11 adapted to deliver advertising content (preferably high quality multimedia ads, similar to television commercials) provided by the advertisers (or other content providers) to subscribers via their cellular phones 12. For simplicity, only one phone 12 is shown in FIG. 1. In the illustrative embodiment of FIG. 1, the server-side system 11 and phone 12 can communicate via carrier (through a mobile network operator 14) or a Wi-Fi connection 16, or by connecting the phone 12 to a computer 18 that is connected to the internet 19. Other communications protocols may also be used without departing from the scope of the present teachings.

The advertising service provides each phone 12 with an “ad manager” program 20, which is client-side software stored in the phone's internal memory and executed by the phone's processor. The ad manager 20 includes a downloading applet 22 that manages the downloading and storing of ads received from the advertising system 10. In a preferred embodiment, the advertising system 10 embeds a scheduled playback time with each transmitted ad. Ads may be transmitted to the phone 12 at any time prior to the scheduled playback time. The downloading applet 22 stores the ads in the phone's memory until they are viewed by the subscriber. The downloading of ads is preferably invisible to the subscriber and does not interrupt or otherwise affect normal phone usage.

The phone ad manager 22 also includes a playback applet 24 that manages the playback of the ads. At the scheduled playback time, the playback applet 24 indicates on the phone's display that an ad is available for viewing. The subscriber can choose to watch the ad at that time, or save it to watch later. In a preferred embodiment, after an ad is played, the playback applet 24 initiates a procedure for confirming that the subscriber actually watched the ad. For example, the applet 24 may display instructions on the screen to press a particular keypad within a particular amount of time (say, for example, ten seconds). If the subscriber follows the instructions within the allotted time, he is awarded credits for watching the ad. The credits can then be used for purchasing goods or services. This procedure allows the system 10 to confirm to the advertiser not only that the ad was displayed, but also that the subscriber was actually watching it.

In accordance with the present teachings, the ad manager 20 also includes a monitoring applet 26 for monitoring the subscriber's behavior, particularly his response to ads. The monitoring applet 26 may record, for example: whether an ad was downloaded successfully, at what time the ad was played, whether the subscriber watched the ad in its entirety (as indicated by his following of the subsequent screen instructions as described above), whether the ad was saved, the user's actions after viewing the ad, etc.

Each ad preferably includes one or more ways to measure or determine the user's response to the ad (e.g., whether or not the user had a positive response to the ad). In an illustrative embodiment, some ads may be followed with a query, such as “Did you like this ad?” which indicates whether his response to the ad was positive or negative. This query may be combined with the confirmation procedure discussed above (i.e., the user is instructed to answer the query within the allotted time in order to receive credit for watching the ad).

In addition, some ads may include an offer from the advertiser, such as a coupon for free or discounted goods or services. The playback applet 24 gives the subscriber the option of deleting the offer, or saving it. The coupon may include a code that can be entered at online stores and/or a barcode that can be displayed on the phone and scanned by a merchant to receive the advertised offer. In a preferred embodiment, a unique code is given to each subscriber. When the code is used at a store, data is transmitted from the store to the advertising system 10, confirming that the code was used. This allows the system 10 to track which subscribers actually use their coupons and also when they use the coupons (use of a coupon indicates a favorable response to the ad).

Other methods may also be used to help the system 10 determine whether or not a subscriber responds favorably to an ad. For example, certain actions made by the user (such as initiating a search for the nearest store, visiting an advertised website or calling an advertised phone number, saving an ad, forwarding an ad to a friend, etc.) after viewing an ad may indicate a positive response.

In a preferred embodiment, the monitoring applet 26 also monitors and records other subscriber behavior patterns, such as phone usage, phone location, web browsing, purchases made via the phone, methods used to access or communicate digital information (e.g., Bluetooth, Wi-Fi, USB, etc.), and any other recordable metrics that may be useful to the system 10 for modeling the subscriber's behavior and predicting how he will respond to future ads. The monitoring applet 26 accumulates and saves the subscriber's behavior patterns and responses to ads in a data file and transmits the file to the server-side system 11 periodically (such as once a day). In the illustrative embodiment of FIG. 1, the monitored data files are transmitted from the phone 12 to the server 11 via carrier; however, the data may also be transmitted via Wi-Fi, satellite, USB, or any other communication method without departing from the scope of the present teachings.

In accordance with the present teachings, the advertising system 10 includes a server-side system 11 that uses the data obtained by the monitoring applet 26 to optimize the delivery of ads to the subscribers, by recommending the best subscribers to receive a particular ad, the best time to schedule an ad, the price for delivering the ad, and the best time and method to transmit the ads to the phones. In the illustrative embodiment, the server-side system 11 is implemented in software stored in and executed by a bank of servers 28.

The server-side system 11 includes a subscriber-side sub-system 30, a provider-side sub-system 40, and a delivery sub-system 50, plus a subscriber profile database 34 and a content database 48. The subscriber-side sub-system 30 receives the data monitored by the cellular phones 12 and uses the data to update a profile on each subscriber. The subscriber profiles are then stored in the subscriber profile database 34. Each subscriber profile includes information about the subscriber's demographic details and personal preferences, as well as his recorded behavior patterns and responses to ads. The provider-side sub-system 40 uses the subscriber profiles to help the advertisers (the content providers) refine their advertising campaigns, including the selection of which subscribers should be targeted to receive their ads, which are stored in the content database 48. The delivery sub-system 50 then uses the recorded subscriber behavior patterns to determine the optimal time and routing method to transmit the ads to the cellular phones 12 of each selected subscriber.

In operation, advertisers interact with the provider-side sub-system 40 to upload their ads to the content database 48 and specify the parameters of their advertising campaign, including the demographics they want to reach and when they want to schedule their ads for playback. The provider-side sub-system 40 uses the subscriber profiles stored in the subscriber database 34 to provide the advertisers with intelligent information about the specific individual behavior patterns of each subscriber as to their approval/acceptance or disapproval/rejection of particular advertising campaigns, and makes recommendations on an optimal advertising campaign. The advertisers may choose to use the system recommendations or override them and use their own campaign parameters.

In an illustrative embodiment, the provider-side sub-system 40 includes a predictive engine 42 for predicting how subscribers will respond to a particular advertising campaign based on their personal preferences and recorded behavior patterns stored in the profile database 34, and recommending which subscribers should be targeted to receive the ad in order to maximize the predicted subscriber acceptance of the campaign. In particular, the predictive engine 42 identifies the “high uptake” subscribers that are predicted to have a high probability of having a positive response to a particular ad campaign. The predictive engine 42 may also make recommendations on how to modify the campaign parameters in order to improve the predicted acceptance of an ad by selected “low uptake” subscribers (subscribers predicted to have a low probability of having a positive response to the ad campaign).

In a preferred embodiment, the predictive engine 42 is an artificial intelligence engine implemented using a neural network comprised of a plurality of interconnected neural nodes. The output of each neural node is a weighted sum of its inputs, and the weights of the inputs are adaptive, changing based on the information presented to the network during a training mode. The predictive engine 42 is trained by the subscriber-side sub-system 30 using the subscribers' monitored behavior and responses to previous ads. The subscriber-side sub-system 30 includes an algorithm for determining the weights for the neural network 42 based on the subscriber's behavior and responses, and saves the weights to the subscriber's profile. When new subscriber data is received by the subscriber-side sub-system 30, new weights are calculated and the profile is updated accordingly.

By presenting the neural network 42 with data on how the subscribers responded to previous ads, the predictive engine 42 can model the subscribers' behavior and predict how they will respond to new ads. In a preferred embodiment, the predictive engine 42 estimates the probability that a subscriber will have a positive response to an ad based on characteristics of the ad (including the ad type/category and the specific product or service being advertised) and ad campaign. The predictive engine 42 may also be designed to search for patterns in the subscribers' behavior and prior responses that may be used to modify the ad or ad campaign parameters in order to improve the subscribers' responses.

For a more detailed description of an illustrative provider-side sub-system 40 and predictive engine 42, -see the co-pending patent application entitled “SYSTEM AND METHOD FOR PREDICTING THE OPTIMUM DELIVERY OF MULTIMEDIA CONTENT BASED ON HUMAN BEHAVIOR PATTERNS”, by R. B. Hubbard (Atty. Docket No. Hubbard-1), the teachings of which are incorporated herein by reference.

The provider-side sub-system 40 may also include a scheduling engine 44 for recommending the best time to schedule an ad based on subscriber behavior patterns. In a preferred embodiment, the scheduling engine 44 recommends the best time slot that matches when the subscribers in the targeted demographic prefer to watch their ads, based on their monitored usage patterns (such as at what times the subscriber has previously watched his ads), which are recorded by the monitoring applet 26. An illustrative scheduling engine 44 suitable for this application is described in a co-pending patent application entitled “SYSTEM AND METHOD FOR OPTIMIZING THE SCHEDULING OF MULTIMEDIA CONTENT”, by R. B. Hubbard (Atty. Docket No. Hubbard-4), the teachings of which are incorporated herein by reference.

The provider -side sub-system 40 may also include a billing engine 46 for automatically computing the cost to the advertiser for a particular campaign. In a preferred embodiment, the billing engine 46 sets the price of an ad campaign for an advertiser based on ad type, frequency and volume of ads to be sent, campaign duration, and the acceptance rate of the targeted subscribers. An illustrative billing engine 46 is described in a co-pending patent application entitled “SYSTEM AND METHOD FOR OPTIMIZING THE PRICING OF MULTIMEDIA CONTENT DELIVERY”, by R. B. Hubbard (Atty. Docket No. Hubbard-5), the teachings of which are incorporated herein by reference.

After a campaign is approved by the advertiser, the delivery sub-system 50 transmits the ads to the selected subscribers' cellular phones 12. In a preferred embodiment, the delivery sub-system 50 includes a routing engine 52 that determines the best time and method for transmitting ads to the phones 12. Certain phones are capable of communicating using more than one form of data transmission. For example, a dual-mode phone may be equipped to communicate using a cellular network or a Wi-Fi network, which is typically cheaper and faster than cellular transmission. In a preferred embodiment, the routing engine 52 analyzes a subscriber's behavior patterns, particularly relating to his locations and the transmission methods available at those locations, to determine the best predicted time to send ads to the subscriber in order to minimize transmission costs. An illustrative routing engine 52 is described in a co-pending patent application entitled “SYSTEM AND METHOD FOR OPTIMIZING THE ROUTING OF MULTIMEDIA CONTENT”, by R. B. Hubbard (Atty. Docket No. Hubbard-3), the teachings of which are incorporated herein by reference.

After ads are downloaded to a subscriber's phone 12, the playback applet 24 on the phone will notify the subscriber that an ad is available for viewing at the scheduled playback time. The subscriber can view the ad at that time, or save it and view it later. After the subscriber watches the ad, the monitoring applet 26 records the subscriber's responses. The recorded responses and monitored subscriber behavior patterns are then transmitted to the subscriber-side sub-system 30.

The subscriber-side sub-system 30 generates and maintains the subscriber profiles that are used by the provider-side sub-system 40 to predict an optimal campaign. The subscriber-side sub-system 30 receives the monitored data from each phone 12, and may also receive data from other sources such as merchants (regarding, for example, coupon use as discussed above) or a website that allows subscribers to manually modify their personal preferences and demographic information. The subscriber-side sub-system 30 then sifts through the received data and saves relevant information to the subscribers' profiles. For example, the subscriber-side system 30 keeps track of when subscribers watch their ads, how quickly they respond to ads, how often they use coupons, their actions after viewing an ad, etc.

In an illustrative embodiment, each subscriber's profile is generated when the subscriber registers for the advertising service. The subscriber is asked to provide some basic demographic information (age, gender, location, etc.) and preferences on a short list of general ad categories (sports, politics, music, etc.). This information may be obtained, for example, through a website, entered manually on a registration form, or transmitted by the phone.

In accordance with the present teachings, the subscriber-side sub-system 30 includes profile refining engine 32 for automatically refining a subscriber's personal preferences based on the subscriber's responses to ads. Instead of asking the subscriber to answer a long questionnaire detailing their personal preferences on a multitude of different subjects, the profiling engine 32 gradually obtains this information over time as the subscriber continues using the advertising service. During the registration process, the subscriber is asked to provide their preferences for only a few broad categories of subjects, indicating to the system 10 whether the subscriber would be interested in receiving ads relating to, for example, sports, music, movies, food, politics, etc. The profiling engine 32 then refines the profile to include more detailed information about the subscriber's preferences, such as types of sports he prefers, specific teams and athletes that he likes, etc. The profiling engine 32 obtains this information by analyzing the subscriber's behavior patterns and responses to previous ads. Thus, the more the subscriber uses the advertising service, the more refined or detailed the subscriber's profile becomes. After the profiling engine 32 has refined the profile as much as desired, it continues to monitor the subscriber's responses for any changes to his preferences and updates the profile accordingly.

By automatically refining and updating the subscriber profiles in this manner, the amount of labor required of the subscriber to use the advertising service is minimized, increasingly the likelihood that the subscriber will remain with the service longer since the “work” is done for them and they continue to receive a benefit for doing next to nothing. Optionally, the system 10 may also include a web interface or other method for allowing the subscriber to make manual changes to the demographic or preference information in their profile.

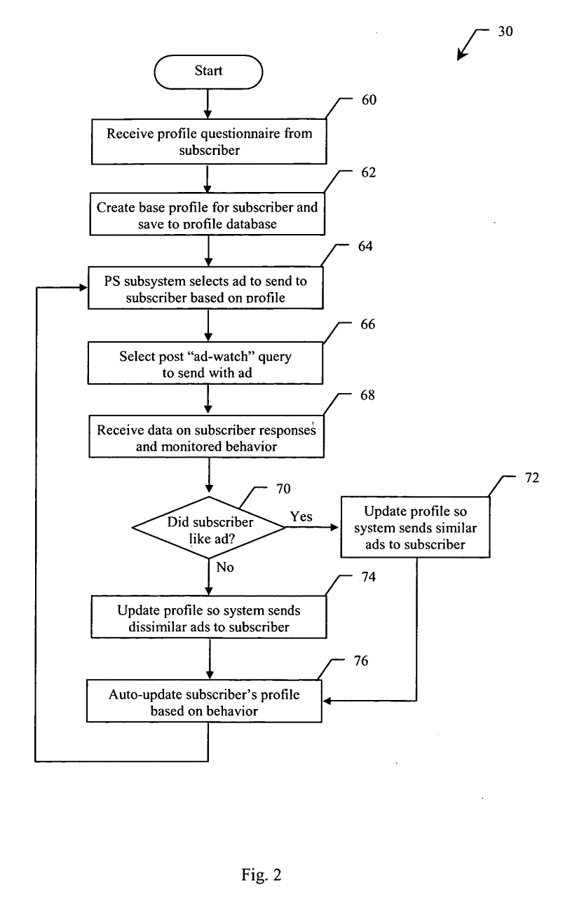

FIG. 2 is a simplified flow diagram of a subscriber-side sub-system 30 designed in accordance with an illustrative embodiment of the present invention.

First, at Step 60, the subscriber-side sub-system 30 receives a profile questionnaire from the subscriber. This is the initial questionnaire that is requested upon first registering for the advertising service, and includes some basic demographic information (age, gender, location, etc.) and the subscriber's preferences on a few general ad categories (sports, politics, music, etc.). This information may be obtained, for example, through a website, entered manually on a registration form, or transmitted by the phone.

At Step 62, the subscriber-side sub-system 30 creates a base profile for the subscriber using the information provided in the questionnaire and saves it to the profile database 34. Once a profile for the subscriber is in the database 34, the system 10 can begin sending the subscriber ads, in accordance with the subscriber's preferences as indicated in his profile.

When an ad is scheduled to be sent to a subscriber, at Step 64, the provider-side sub-system 40 notifies the subscriber-side sub-system 30. At Step 66, the subscriber-side sub-system 30 selects a post “ad-watch” query to send with the ad. The query is transmitted along with the ad to the phone 12. The playback applet 24 running on the phone 12 displays the query after the ad is viewed by the subscriber.

In accordance with the present teachings, a post “ad-watch” query is presented to the subscriber after an ad is played to help the profiling engine 32 refine the subscriber's profile. In one illustrative embodiment, the query simply asks the subscriber, “Did you like this ad?” Upon receiving the subscriber's response, the profiling engine 32 updates the subscriber's profile accordingly. If the subscriber indicates that he liked the ad, the profiling engine 32 updates the profile so the system will continue sending similar ads to the subscriber. If the subscriber indicates that he did not like the ad, the profiling engine 32 updates the profile so the system sends him dissimilar ads. The profiling engine 32 searches for patterns in the subscriber's responses over several ads. Over time, the subscriber's profile provides a more detailed representation of the subscriber's personal preferences. For example, if a subscriber indicates in his initial profile that he likes sports, the system 10 will begin sending him various sports related ads with the query “Did you like this ad?” following each ad. After sending the subscriber several sports related ads, the profiling engine 32 may notice that the subscriber usually likes football related ads but not basketball related ads. The profiling engine 32 will therefore update the subscriber's profile to indicate that he likes football and not basketball.

Alternatively, instead of simply asking, “Did you like this ad?” the profiling engine 32 may ask a more direct question designed to acquire specific information about the subscriber's preferences. For example, after the profiling engine 32 determines that the subscriber likes football and not basketball, the profiling engine 32 updates the subscriber's profile to stop sending him basketball related ads and continue sending football related ads, and indicates that the next times football related ads are sent, they should be followed with queries asking what type(s) of football he likes (e.g., college, pro, Canadian, etc.). If, in response to this series of queries, the subscriber indicates that he likes pro football, the next queries (sent with the next football related ads delivered to the subscriber) might ask which teams he likes, followed by who his favorite athletes are, and so on.

Thus, each refinement or change to the subscriber's profile may trigger the profiling engine 32 to “branch” the subscriber onto a new path, selecting new queries for further refining the subscriber's personal preferences.

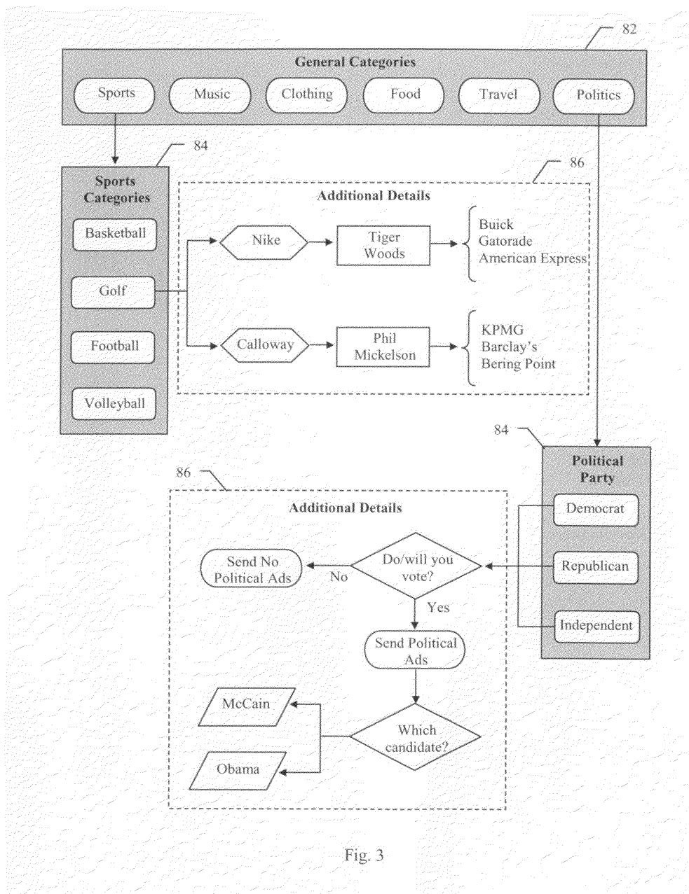

FIG. 3 is a simplified diagram showing illustrative tree branching examples for creating the rules that define the profiling engine responses to updating a subscriber's profile. A subscriber's profile initially includes the subscriber's preferences on a few general categories 82 that are obtained during the initial questionnaire. As the subscriber uses the advertising service, the subscriber-side sub-system 30 obtains more details about the subscriber's preferences. FIG. 3 shows an example of some of the detailed preferences that may be obtained by the profiling engine 32.

In the example of FIG. 3, the general categories 82 include sports, music, clothing, food, travel, and politics. Each of the general categories 82 may branch into several sub-categories 84, and each of the sub-categories 84 may branch into several additional details 86. For example, the general category “sports” may branch into several different types of sports, such as basketball, golf, football, volleyball, etc. Each type of sport may lead to additional details about that sport. For example, if a subscriber indicates that he likes golf, the profiling engine 32 attempts to determine additional preferences such as which brand of golfing equipment he prefers (e.g., Nike or Calloway, as shown in FIG. 3) and his favorite professional golfer (Tiger Woods or Phil Mickelson). These detailed preferences are saved to the subscriber's profile and are used by the provider-side sub-system 40 to help predict which ads the subscriber will be more receptive to. For example, if a subscriber indicates that his favorite golfer is Tiger Woods, he may be more receptive to products used by or endorsed by Tiger such as Nike, Buick, Gatorade, American Express, etc.

In an illustrative embodiment, the profiling engine 32 obtains the detailed personal preferences of the subscriber by attaching queries to be played after an ad is viewed. The queries may includes questions such as “Do you like basketball?” or “Do you prefer Nike or Calloway for golf equipment?”. Each positive response to a query leads to the profiling engine 32 creating additional questions for the subscriber for refining his profile to the next logical path.

For example, as shown in FIG. 3, if the subscriber indicates in his initial questionnaire that he is interested in politics, the profiling engine 32 may send a query asking the subscriber for his political party affiliation (e.g., Democrat, Republican, or Independent). After receiving a response, the next query might be, “Do you vote?”. If the subscriber responds no, the engine 32 updates the subscriber's profile to stop sending political ads. If the subscriber responds yes, the profiling engine 32 will add additional queries to determine the subscriber's specific political views such as, “Which presidential candidate do you prefer?”.

Thus, the profiling engine 32 selects a series of queries for the subscriber based on the subscriber's responses to previous queries. The queries are sent to the subscriber over time to determine his preferences on several different subjects. Each response to a query may lead to additional queries. In a preferred embodiment, only one question is asked after each ad in order to avoid overwhelming the subscriber. While the profiling engine 32 may include a huge list of personal preference subcategories and associated queries, most of these are never presented to the subscriber since a particular query is only sent when triggered by the corresponding response to a previous query.

In a preferred embodiment, the profiling engine 32 is an adaptive neural network artificial intelligence (AI) engine comprised of a plurality of interconnected neural nodes that perform the profile refining tasks described above. The first step to developing a neural node is to identify what adaptive functions the node is expected to perform. This is accomplished by creating a “rule set” to test the conditions of the business process. A rule set is essentially code that can be extracted into any preferred language, such as C++ or C#, as a set of hard-coded programmatic instructions with the ability to adjust its behavior related to changes in the environment in which it is monitoring. Once the rule set is determined and tested to meet all conditions, a stable engine then exists. It is at this point that the adaptive neural node can be created.

The profiling Al engine 32 has to perform these tasks for potentially millions of subscribers and update profiles on a minute-by-minute basis in order to improve the experience for both the advertisers and the targeted subscribers. This is a high performance, highly adaptive task that needs an adaptable engine that has hard-coded “base” rules to work from, and then change as needed on its own, based on the behavior patterns of the targeted subscribers.

Returning to FIG. 2, at Step 66, the profile refining engine 32 selects a query to send with the ad. The ad, along with the query and the scheduled playback time, is sent to the subscriber's phone 12 by the delivery sub-system 50. After the subscriber views the ad, the playback applet 24 running on the phone 12 displays the attached query and receives a response from the subscriber. The monitoring applet 26 saves the subscriber's response to the query along with other subscriber behavior patterns to a data file that is transmitted to the subscriber-side sub-system 30. This data may be sent immediately after acquiring the subscriber's response, or the monitoring applet 26 may continue saving subscriber actions and responses to the file and send it periodically (such as once a day).

At Step 68, the subscriber-side sub-system 30 receives the data file from the phone 12 and sifts through the data for useful information that can be used to update the subscriber's profile.

At Step 70, the profiling engine 32 looks for the subscriber's response to any queries and updates the subscriber's preferences accordingly. For example, if the subscriber was asked “Did you like this ad?” and the subscriber responds yes, then at Step 72, the profiling Al engine 32 updates the profile so the system sends similar ads to the subscriber. If the subscriber responds no, then at Step 74, the profiling AI engine 32 updates the profile so the system sends dissimilar ads to the subscriber. As described above, an update or change to the subscriber's preferences may trigger the selection of a new query or queries for the subscriber. These queries are saved to the subscriber profile for transmission with the next ads sent to the subscriber.

At Step 76, the profiling engine 32 looks for subscriber behavior patterns in the data file and updates the subscriber's profile accordingly. For example, the profiling engine 32 monitors how often the subscriber uses coupons, how long after viewing an ad he uses an associated coupon, what times he watches ads, phone usage in response to ads, purchases made via phone, web browsing history, phone location history, and any other recordable metrics that may be useful to the system 10.

The next time the provider-side sub-system 40 sends another ad to the subscriber (Step 64), the profiling engine 32 attaches the next selected query to the ad and the process repeats.

The subscriber sub-system 30 monitors each subscriber's behavior and responses in this manner, generating and maintaining a profile for each subscriber. Even after the profiling engine 32 has refined the subscriber's preferences as much as possible (as defined by the profiling engine 32 rule set), the subscriber sub-system 30 continues to monitor the subscriber's responses, looking for any changes to the subscriber's behavior or preferences. For example, a subscriber may stop liking fast food restaurants and start preferring healthy foods. This change would then be reflected in the subscriber's responses to food related ads. Because the subscriber sub-system 30 continually monitors the subscriber's responses, the profiling engine 32 will notice the change and update the subscriber's profile accordingly.

Thus, the present invention has been described herein with reference to a particular embodiment for a particular application. Those having ordinary skill in the art and access to the present teachings will recognize additional modifications, applications and embodiments within the scope thereof. For example, while the invention has been described with reference to an application for delivering advertisements to cellular phones, the present teachings may also used for delivering other types of multimedia content or for delivering to other types of media storage devices.

It is therefore intended by the appended claims to cover any and all such applications, modifications and embodiments within the scope of the present invention.

Accordingly,

What is claimed is:

1. A system for monitoring a subscriber's behavior comprising:
first means for obtaining a subscriber's responses to multimedia content previously delivered to said subscriber's device and
second means for modifying a profile on said subscriber based on said responses.

2. The invention of claim 1 wherein said profile includes data on said subscriber's personal preferences on a plurality of categories.

3. The invention of claim 2 wherein said second means includes a subscriber sub-system for automatically refining said personal preferences based on said responses.

4. The invention of claim 3 wherein said second means includes means for sending a particular query to said subscriber when a corresponding personal preference is modified.

5. The invention of claim 3 wherein said second means includes means for selecting a query to send to said subscriber based on said responses.

6. The invention of claim 5 wherein said second means includes means for attaching said query to multimedia content to be transmitted to said subscriber.

7. The invention of claim 6 wherein said system further includes a first applet stored in and executed by said device adapted to receive said content and query and display said query after said content is viewed by said subscriber.

8. The invention of claim 7 wherein said first means includes a second applet stored in and executed by said device adapted to record said subscriber's responses and actions in a data file.

9. The invention of claim 8 wherein said second applet is adapted to transmit said data file to said subscriber sub-system.

10. The invention of claim 9 wherein said subscriber-side sub-system is adapted to receive said recorded responses and actions from said second applet and update said subscriber profile accordingly.

11. The invention of claim 1 wherein said system further includes a database for storing profiles on a plurality of subscribers.

12. The invention of claim 1 wherein said second means includes a neural network artificial intelligence engine.

13. The invention of claim 1 wherein said content includes advertisements.

14. The invention of claim 1 wherein said device includes a cellular phone.

15. A system for monitoring a subscriber's behavior comprising:
an applet stored in and executed by a subscriber's media storage device for recording said subscriber's responses to multimedia content previously delivered to said media storage device and
a server adapted to receive said recorded responses from said applet and update said profile accordingly.

16. A system for delivering multimedia content to subscribers' media storage devices comprising:
a database for storing profiles on a plurality of subscribers;
an applet stored in and executed by each of said subscribers' media storage devices adapted to record a subscriber's responses to multimedia content previously delivered to said device;
a subscriber-side sub-system for receiving said recorded responses from said applets and updating said profiles accordingly;
a provider-side sub-system for selecting subscribers to receive new content based on said profiles; and
a delivery sub-system for delivering said new content to each selected subscriber's media storage device.

17. A method for monitoring a subscriber's behavior including the steps of:
obtaining a subscriber's responses to multimedia content previously delivered to said subscriber's device and
modifying a profile on said subscriber based on said responses.
